(19) United States
(12) Patent Application Publication
(10) Pub. No.: US 2020/0181031 A1
(43) Pub. Date: Jun. 11, 2020

(54) DEFOAMER EMULSION

(71) Applicant: BASF SE, Ludwigshafen am Rhein (DE)

(72) Inventors: Shi Cheng LI, Shanghai (CN); Yi Heng WANG, Shanghai (CN); Ping HE, Shanghai (CN)

(73) Assignee: BASF SE, Ludwigshafen am Rhein (DE)

(21) Appl. No.: 16/614,524

(22) PCT Filed: May 15, 2018
(86) PCT No.: PCT/EP2018/062429

§ 371 Date: Nov. 18, 2019

(30) Foreign Application Priority Data
May 19, 2017 (CN) PCT/CN2017/085139

(51) Int. Cl. C04B 40/00; C04B 24/16; C04B 24/32; C04B 24/42; C04B 24/12; C04B 24/26; C04B 28/02

(52) U.S. Cl. CPC C04B 40/0046; C04B 24/16; C04B 24/32; C04B 24/42; C04B 2103/50; C04B 24/2652; C04B 40/005; C04B 28/02; C04B 24/122

(57) ABSTRACT

The present invention relates to a defoamer emulsion, which comprises at least one alkyl ether sulfate or sulfonate, at least one defoamer and water, wherein the alkyl in the alkyl ether sulfate or sulfonate is C₆-C₂₂ alkyl and the average droplet diameter of the emulsion is less than 300 nm. The present invention also provides a process for producing it, a polycarboxylate ether formulation comprising the defoamer emulsion and a cement composition comprising the polycarboxylate ether formulation. The defoamer emulsion of the present invention possesses high transmittance and excellent stability. The polycarboxylate ether formulation comprising the defoamer emulsion also shows excellent stability. The cement composition comprises the polycarboxylate ether formulation according to the present invention has a low air content.

### TECHNOLOGY FIELD

The invention relates to a defoamer emulsion, to a process for producing it, to a polycarboxylate ether formulation comprising the defoamer emulsion and to a cement composition comprising the polycarboxylate ether formulation.

### BACKGROUND

It is known to use polycarboxylate ether in cement composition. Polycarboxylate ether can increase the flowability of cement composition and reduce the water content thereof. The reduction of water content can increase the strength of the resulting cement formation.

However, the employment of polycarboxylate ether has a tendency to entrain air in the cement composition and an excess of entrained air is detrimental to the compressive strength of the resulting cement formation.

Defoamer can be added to the cement composition to remove the excess air entrained in the cement composition. Usually, a defoamer is added to the polycarboxylate ether formulation. However, the defoamer used is usually water insoluble and polycarboxylate ether is generally water soluble. When a defoamer is used in combination with a water soluble polycarboxylate ether, the resulted formulation will separate over time.

CN1244184A discloses chemical admixtures used in cement compositions. The admixtures are formed by emulsifying an antifoaming agent with a “comb” polymer having a carbon-containing backbone to which are attached cement-anchoring members and oxyalkylene groups. The example part of this application shows that the air content of the cement composition obtained by using said admixture is relatively high.

There is still a need to develop a stable deformer emulsion, by using which a stable polycarboxylate ether formulation can be obtained and the cement composition prepared by using the polycarboxylate ether formulation has a low air content.

### SUMMARY OF THE INVENTION

It is therefore an object of the invention to provide a stable defoamer emulsion, by using which a stable polycarboxylate ether formulation can be obtained. The polycarboxylate ether formulation has excellent stability and the cement composition prepared by using the polycarboxylate ether formulation has a low air content.

Another object of the present invention is to provide a process for producing the defoamer emulsion.

A further object of the present invention is to provide a process for producing the polycarboxylate ether formulation.

A further object of the present invention is to provide a process for producing the cement composition.

It has been surprisingly found that the above objects can be achieved by a special defoamer emulsion comprising at least one alkyl ether sulfate or sulfonate, at least one defoamer and water.

Therefore, the present invention relates to the following aspects.

1. A defoamer emulsion, which comprises at least one alkyl ether sulfate or sulfonate, at least one defoamer and water, wherein the alkyl in the alkyl ether sulfate or sulfonate is C₆-C₂₂ alkyl and the average droplet diameter of the emulsion is less than 300 nm.

2. The defoamer emulsion according to item 1, wherein the alkyl in the alkyl ether sulfate or sulfonate is C₈-C₁₈ alkyl, preferably C₁₂-C₁₈ alkyl.

3. The defoamer emulsion according to item 1 or 2, wherein the alkyl ether sulfate or sulfonate is a sulfate or sulfonate of polyethoxylated alkanols.

4. The defoamer emulsion according to item 3, wherein the sulfate or sulfonate of polyethoxylated alkanols has 4 to 80 oxyethylene units, preferably 8 to 60 oxyethylene units, more preferably 12 to 50 oxyethylene units.

5. The defoamer emulsion according to any of items 1 to 4, wherein the defoamer is a water-insoluble defoamer.

6. The defoamer emulsion according to any of items 1 to 5, wherein the defoamer is selected from a silicon oil, a silicon containing emulsion, a fatty acid, a fatty acid ester, an organic modified polysiloxane, a borate ester, a polyalkoxylate, a polyoxyalkylene copolymer, acetylenic diols having defoaming properties and a phosphoric ester having the formula P(O)(OR₈)₃₋ₓ(OR₉)ₓ wherein P represents phosphorus, O represents oxygen and R₈ and R₉ are independently C₂-C₂₀ alkyl or C₆-C₁₄ aryl group and x is 0, 1 or 2, and mixtures thereof, preferably from a silicon oil, a silicon containing emulsion, an organic modified polysiloxane, a polyalkoxylate, a polyoxyalkylene copolymer, acetylenic diols having defoaming properties and a phosphoric ester having the formula P(O)(OR₈)₃₋ₓ(OR₉)ₓ wherein P represents phosphorus, O represents oxygen and R₈ and R₉ are independently C₂-C₈ alkyl and x is 0, 1 or 2, and mixture thereof, more preferably from the defoamer is selected from propoxylated alcohol, organic modified polysiloxane and mixture thereof.

7. The defoamer emulsion according to any of items 1 to 6, wherein the emulsion further comprises at least one additive selected from polyvinylpyrrolidone, diethanol amine, triethanol amine, ethylene glycol, urea, carbonate salt and mixture thereof.

8. The defoamer emulsion according to item 7, wherein said additive is used in an amount of from 5 to 15 wt % when the additive is polyvinylpyrrolidone, or in an amount of from 1 to 8 wt % when the additive is selected from diethanol amine, triethanol amine, ethylene glycol, urea, carbonate salt and mixture thereof, based on the total weight of the emulsion.

9. The defoamer emulsion according to item 7 or 8, wherein number average molecular weight of the polyvinylpyrrolidone is in the range from 5,000 to 20,000.

10. The defoamer emulsion according to any of items 1 to 9, wherein the average droplet diameter of the emulsion is from 80 to 300 nm, preferably 90 to 250 nm, more preferably from 90 to 150 nm.

11. The defoamer emulsion according to any of items 1 to 10, wherein the concentration of the alkyl ether sulfate or sulfonate in the defoamer emulsion is from 5 to 20 wt %, preferably from 8 to 15 wt %.

12. The defoamer emulsion according to any of items 1 to 11, wherein the weight ratio of the alkyl ether sulfate or sulfonate to the defoamer is from 0.15:1 to 0.8:1, preferably from 0.2:1 to 0.5:1, more preferably from 0.3:1 to 0.4:1.

13. A process for producing the defoamer emulsion according to any of items 1 to 12, which comprises
step a) preparing a mixture comprising the alkyl ether sulfate or sulfonate, the defoamer and water;
step b) optionally subjecting the mixture to a low shear, preferably the stirring rate in the low shear being in the range from 50 to 500 rpm, more preferably 100 to 300 rpm; and
step c) shearing the mixture at a shear rate of at least 25,000 s⁻¹, preferably at least 50,000 s⁻¹, more preferably from 70,000 s⁻¹, to 180,000 s⁻¹ for at least 10 minutes, preferably at least 20 minutes, more preferably 20 to 120 minutes, most preferably 30 to 60 minutes.

14. The process according to item 13, wherein step a) is carried out by dissolving the alkyl ether sulfate or sulfonate in the water and adding the defoamer to the resulted solution or step a) is carried out by adding the alkyl ether sulfate or sulfonate and the defoamer to the water simultaneously.

15. A defoamer emulsion obtainable by the process according to item 13 or 14.

16. A polycarboxylate ether formulation, which comprises at least one polycarboxylate ether and a defoamer emulsion as defined in any of items 1 to 12 or item 15.

17. The polycarboxylate ether formulation according to item 16, wherein the polycarboxylate ether comprising a polycarboxylate moiety and an ether moiety.

18. The polycarboxylate ether formulation according to item 17, the polycarboxylate moiety is a carbon containing backbone bearing carboxylic acid group and/or an ester and/or salt thereof, and optional sulfonic acid group and/or a salt thereof.

19. The polycarboxylate ether formulation according to item 17 or 18, wherein the weight ratio between the polycarboxylate moiety and the ether moiety is from 3:7 to 99 :1, preferably from 4:6 to 95:5, more preferably from 6:4 to 8:2.

20. The polycarboxylate ether formulation according to any of items 16 to 19, wherein the content of the polycarboxylate ether in the polycarboxylate ether formulation is from 5 to 40 wt %, preferably 10 to 30 wt %, and the polycarboxylate ether formulation comprises 0.1 to 5 wt %, preferably 0.2 to 2 wt %, and most preferably 0.4 to 1 wt % of the defoamer emulsion as defined in any of items 1 to 12 or item 15, based on the total weight of the formulation.

21. A process for producing the polycarboxylate ether formulation according to any of items 16 to 20, which comprises mixing the defoamer emulsion as defined in any of items 1 to 12 or item 15 with the polycarboxylate ether.

22. A process according to item 21, wherein partial or total amount of additives as defined in any of items 7 to 9 are added when producing the polycarboxylate ether formulation.

23. A cement composition, which comprises at least one cement and the polycarboxylate ether formulation as defined in any of items 16 to 20.

24. The cement composition according to item 23, wherein the cement is selected from portland cement, masonry cement, alumina cement, refractory cement, magnesia cement, calcium sulfoaluminate cement, oil well cement, and mixtures thereof.

25. The cement composition according to item 23 or 24, wherein the cement composition comprises 0.05 to 1 wt %, preferably 0.1 to 0.3 wt % of the polycarboxylate ether formulation as defined in any of items 16 to 20.

26. A process for producing the cement composition as defined in any of items 23 to 25, which comprises mixing the cement, water and the polycarboxylate ether formulation as defined in any of items 16 to 20.

### EMBODIMENT OF THE INVENTION

In one embodiment, the present invention provides a defoamer emulsion, which comprise at least one alkyl ether sulfate or sulfonate, at least one defoamer and water, wherein the alkyl in the alkyl ether sulfate or sulfonate is C₆-C₂₂-alkyl and the average droplet diameter of the emulsion is less than 300 nm.

The undefined article “a” , “an” , “the” means one or more of the species designated by the term following said article. For example, “a silicon oil” encompasses one or more silicon oils.

According to one preferred embodiment, the alkyl in the alkyl ether sulfate or sulfonate is C₈-C₁₈ alkyl, preferably C₁₂-C₁₈ alkyl. In one embodiment, the alkyl ether sulfate or sulfonate is a sulfate or sulfonate of polyethoxylated alkanols. According to one preferred embodiment, the sulfate or sulfonate of polyethoxylated alkanols has 4 to 80 oxyethylene units, preferably 8 to 60 oxyethylene units, more preferably 12 to 50 oxyethylene units.

According to the present invention, the alkyl ether sulfate or sulfonate includes the ammonium salt, alkylamine salts, such as the isopropylamine salt, alkali metal salts, such as the sodium salt and alkaline earth metals salts, such as magnesium salt.

According to one preferred embodiment, the alkyl ether sulfate or sulfonate can be sodium lauryl ether sulfate or sulfonate comprising 15 to 50 oxyethylene units.

Alkyl ether sulfates or sulfonates can be prepared, for example, by firstly alkoxylating a C₆ to C₂₂-, preferably a C₈ to C₁₈-, more preferably a C₁₂ to C₁₈-fatty alcohol, and then sulfating the alkoxylation product. For the alkoxylation, preference is given to using ethylene oxide.

The concentration of the alkyl ether sulfate or sulfonate in the defoamer emulsion of the present invention can be from 5 to 20 wt %, preferably from 8 to 15 wt %.

In a preferred embodiment, the defoamer is a water-insoluble defoamer.

The defoamer in the defoamer emulsion of the present invention can be selected from a silicon oil, a silicon containing emulsion, a fatty acid, a fatty acid ester, an organic modified polysiloxane, a borate ester, a polyalkoxylate, preferably a propoxylated alcohol, a polyoxyalkylene copolymer, acetylenic diols having defoaming properties and a phosphoric ester having the formula P(O)(OR₈)₃₋ₓ(OR₉)ₓ wherein P represents phosphorus, O represents oxygen and R₈ and R₉ are independently C₂-C₂₀alkyl or C₆-C₁₄ aryl group, preferably C₂-C₈ alkyl and x is 0, 1 or 2, and mixtures thereof.

In one preferred embodiment, the defoamer is selected from a silicon oil, a silicon containing emulsion, an organic modified polysiloxane, a polyalkoxylate, a polyoxyalkylene copolymer, acetylenic diols having defoaming properties and a phosphoric ester having the formula P(O)(OR₈)₃₋ₓ(OR₉)ₓ wherein P represents phosphorus, O represents oxygen and R₈ and R₉ are independently C₂-C₈ alkyl and x is 0, 1 or 2, and mixture thereof.

In one preferred embodiment, the defoamer is selected from propoxylated alcohol and organic modified polysiloxane such as arylalkyl-modified polysiloxanes, a,w-modified propoxylated polydimethyl siloxane, or else fluorosilicones. The number of propylene oxide units in the a,w-modified propoxylated polydimethyl siloxane can be from 20 to 50, preferably 25 to 45.

According to one preferred embodiment, the propoxylated alcohol is a propoxylated C₇-C₂₀ alcohol, preferably a propoxylated C₁₀-C₁₈ alcohol or propoxylated mixture of alcohols containing 7 to 20 carbon atoms. The number of propylene oxide units in the propoxylated alcohol can be from 12 to 50, preferably 18 to 30.

According to one preferred embodiment of the present invention, the weight ratio of the alkyl ether sulfate or sulfonate to the defoamer is from 0.15:1 to 0.8:1, preferably from 0.2:1 to 0.5:1, more preferably from 0.3:1 to 0.4:1.

In an embodiment, the defoamer emulsion further comprises at least one additive for improving the low-temperature stability, which can be selected from polyvinylpyrrolidone, diethanol amine, triethanol amine, ethylene glycol, urea and carbonate salt (preferably alkali carbonate, for example sodium carbonate and potassium carbonate) and mixture thereof. The number average molecular weight of polyvinylpyrrolidone can be from 5,000 to 20,000. The polyvinylpyrrolidone, when used, is used typically in an amount of from 5 to 15 wt %, based on the total weight of the polycarboxylate ether formulation. Diethanol amine, triethanol amine, ethylene glycol, urea and potassium carbonate, when used, is used typically in an amount of from 1 to 8 wt %, preferably from 2 to 5 wt %, based on the total weight of the polycarboxylate ether formulation.

In one preferred embodiment, the average droplet diameter of defoamer emulsion according to the present invention is from 80 to 300 nm, preferably from 90 to 250 nm, more preferably from 90 to 150 nm. Before testing the average droplet diameter, defoamer emulsion can be diluted 500 times by deionized water, for example 0.2 g defoamer emulsion can be diluted by 99.8 g deionized water.

A further embodiment of the present invention relates to a process for producing the defoamer emulsion according to the present invention, which comprises
step a) preparing a mixture comprising the alkyl ether sulfate or sulfonate, the defoamer and water;
step b) optionally subjecting the mixture to a low shear, preferably the stirring rate in the low shear being in the range from 50 to 500 rpm, more preferably 100 to 300 rpm; and
step c) shearing the mixture at a shear rate of at least 25,000 s⁻¹, preferably at least 50,000 s⁻¹, more preferably from 70,000 s⁻¹, to 180,000 s⁻¹ for at least 10 minutes, preferably at least 20 minutes, more preferably 20 to 120 minutes, most preferably 30 to 60 minutes.

According to the present invention, step a) can be carried out by dissolving the alkyl ether sulfate or sulfonate in the water and adding the defoamer to the resulted solution. Step a) can also be carried out by adding the alkyl ether sulfate or sulfonate and the defoamer to the water simultaneously.

Step b) is a low shear step and is an optional step. A rough emulsion can be obtained by step b).

Step c) is a high shear step. A fine emulsion with average droplet diameter as defined above can be obtained by step c).

One aspect of the present invention is directed to a defoamer emulsion obtainable by the process as defined above.

A further embodiment of the present invention relates to a polycarboxylate ether formulation, which comprises at least one polycarboxylate ether and the defoamer emulsion according to the present invention.

The polycarboxylate ether used in the present invention can be a copolymer comprising a polycarboxylate moiety and an ether moiety.

In one preferred embodiment, the polycarboxylate moiety can be a carbon containing backbone bearing carboxylic acid group and/or an ester and/or salt thereof, and optional sulfonic acid group and/or a salt thereof.

Preferably the polycarboxylate ether includes two co-monomer components wherein comonomer component a1) is:
an olefinic unsaturated mono-carboxylic acid co-monomer and/or an ester and/or salt thereof, and/or an olefinic unsaturated sulfonic acid compound as further co-monomer and/or a salt thereof,
and co-monomer component a2) is:
a co-monomer according to the general formula (I)

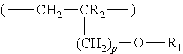

wherein R₁ is

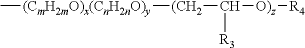

and whereby R₂ is H or aliphatic hydrocarbon group having from 1 to 5 carbon atoms, R₃ is non-substituted or substituted C₆ to C₁₄-aryl group and preferably phenyl, and R₄ is H or aliphatic hydrocarbon group having from 1 to 20 carbon atoms, cycloaliphatic hydrocarbon group having from 5 to 8 carbon atoms, substituted aryl group having from 6 to 14 carbon atoms or a group selected from

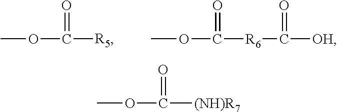

wherein R₅ and R₇ may each be C₁ to C₅-alkyl, C₆ to C₁₄-aryl, C₆ to C₁₀-aralkyl or C₆ to C₁₀-alkaryl group and R₆ may be C₁ to C₆-alkyliden, C₆ to C₁₄-aryliden, C₆ to C₁₀-aralkyliden or C₆ to C₁₀-alkaryliden group and p is 0, 1, 2 or 3, m and n is independently 2, 3, 4 or 5, x and y are independently and integer from 1 to 350, preferably 5 to 200, more preferably 10 to 60, and z is in the range from 0 to 200, preferably is 0 to 100, more preferably is 0 to 50.

Usually, these polymers based on their dispersing properties show excellent plasticizing effects over time and additionally can be prepared by using usual preparation methods. Another aspect may be that the copolymers show their plasticizing effect not only together with specific hydraulic components, but in the field of cementitious mortar and concrete. Additionally, the improved effect of the copolymers can be selectively chosen based on the broad variety of the ether co-monomer and especially based on the broad scope of the side chain length.

The copolymer exhibits especially more advantageous properties when the weight ratio between the polycarboxylate moiety, preferably the co-monomer component a1) and the ether moiety, preferably the ether component a2) is from 3:7 to 99:1.

As used herein, the mentioned co-monomers components a1) and a2), respectively, are to be interpreted as structural units of the copolymer after its polymerization.

In a preferred embodiment, the weight ratio between the polycarboxylate moiety, preferably the co-monomer component a1) and the ether moiety, preferably the co-monomer a2) is from 4:6 to 95:5, preferably from 6:4 to 8:2.

In a preferred embodiment, the ether component a2) with p being 0 or 1 is represented by a vinyl or an allyl group and additionally contains a polyether, preferably polyethylene oxide as R₁. The co-monomer component a1) can be an acrylic acid or a salt thereof.

In general, according to the present invention, the co-monomer component a1) is selected from the group consisting of acrylic acid, methacrylic acid, crotonic acid, isocrotonic acid, maleic acid, fumaric acid, citraconic acid, itaconic acid, (meth)allylsulfonic acid, vinyl sulfonic acid, and their suitable salts or their alkyl or hydroxyalkyl esters, or mixtures thereof.

Alternatively, other co-monomers, such as styrene or acrylamides may be additionally co-polymerized with the ether component a2) and co-monomer component a1). Alternatively, components with hydrophobic properties may be used. Compounds with ether structural units, such as polypropylene oxide or polypropylene oxide-polyethylene oxide (PO/PE) or polybutylene oxide-polyoxyethylene oxide (PB/PE) or polystyrene oxide-polyethylene oxide (PS/PE)-units are preferred. These additional structural units should be represented in the copolymer in amounts up to 5 wt %; amounts from 0.05 to 3 wt % and 0.1 to 1.0 wt % are preferred.

The number average molar mass of polycarboxylate ether can be in the range from 8,000 g mol⁻¹ to 100,000 g mol⁻¹, preferably from 10,000 g mol⁻¹ to 50,000 g mol⁻¹.

The copolymers can be produced by relatively simple methods and especially when the polymerisation is carried out in an oxygen-depleted or oxygen-free atmosphere. There also may be added some amounts of solvents to make the ether component soluble. In the case that co-monomer a2) is a poly-alcoholic group or an alkylene oxide derivatived poly-alcohol group, and R₂ of the ether component is hydrogen, respectively, water is the solvent to be preferred. Alternatively, a mixture of water and alcohol, such as isopropanol, may be added. In the case that R₂ is other than hydrogen, then organic solvents and especially toluene is to be seen as preferred.

For starting the polymerisation reaction, the basic mixture is heated to ambient temperature or smoothly cooled down. Another suitable alternative may be the addition of a redox system as initiator component. This redox system may comprise reducing and oxidizing agents and preferably Rongalite® or Bruggolite® and additionally a peroxide or a persulfate like H₂O₂ or ammonia persulfate. These reagents may be preferably used in systems with water as solvent. Rongalite®, also called Rongalit® (registered trademark of BASF) is sodium hydroxymethylsulfinate. The salt is water-soluble and generally sold as the dihydrate. This salt is prepared from sodium dithionite, it is used both as a reducing agent and as a reagent to introduce SO₂ groups into organic molecules. Bruggolite® (Brüggolit®) of Brüggemann Chemicals is a sodium formaldehyde sulfoxylate (SFS) based reducing agent for the textile, pharmaceutical and bleaching industry.

In principle, two alternatives may be selected to produce the copolymers:

### Alternative A:

The co-monomer mixture and the reducing agent containing mixture are to be added to the ether containing mixture stepwise or continuously; the temperatures range from 0 to 50° C.

### Alternative B:

The mixture containing the oxidizing agent is to be added stepwise to the complete monomer mixture.

Then the reaction mixture is usually stirred until all the peroxide has reacted. In the case that organic solvents are to be used, these will be distilled. The reaction product will then be cooled down and the copolymer is to be neutralized by using a base (such as alkali metals or alkaline earth metals hydroxide, amines or alkanol amines). The addition of an aqueous solution comprising sodium or calcium hydroxide is a preferred alternative.

This disclosed process represents an example for producing the polycarboxylate ether.

The content of the polycarboxylate ether in the polycarboxylate ether formulation is from 5 to 40 wt %, preferably 10 to 30 wt %, based on the total weight of the formulation.

The polycarboxylate ether formulation comprises 0.1 to 5 wt %, preferably 0.2 to 2 wt %, and most preferably 0.4 to 1 wt % of the defoamer emulsion of the present invention, based on the total weight of the formulation.

The polycarboxylate ether formulation according to the present invention can be prepared by mixing the defoamer emulsion according to the present invention with the polycarboxylate ether. According to the present invention, water and optional additive can be further added to prepare the polycarboxylate ether formulation.

According to one embodiment, partial or total amount of additives for improving the low-temperature stability as defined above can be added when preparing the polycarboxylate ether formulation, which means partial or total amount of additives for improving the low-temperature stability are not added when preparing the defoamer emulsion. For example, 20 to 100% by weight, preferably from 40 to 80% by weight of said additives can be added when preparing the polycarboxylate ether formulation, based on the total amount of said additives in the polycarboxylate ether formulation.

A further embodiment of the present invention relates to a cement composition comprising at least one cement and the polycarboxylate ether formulation according to the present invention.

Cements are used to form structural formations. According to the present invention, the cement can be selected from portland cement, masonry cement, alumina cement, refractory cement, magnesia cement, calcium sulfoaluminate cement, oil well cement, and mixtures thereof.

The cement composition of the present invention can be used in combination with any other admixture or additive for cement. Other cement admixtures and additives include, but are not limited to, set retarders, set accelerators, air detraining agents, corrosion inhibitors, any other dispersants for cement, pigments, wetting agents, water soluble polymers, strength enhancing agents, rheology modifying agents, water repellents, and any other admixture or additive that does not adversely affect the properties of the admixture of the present invention.

In one embodiment, the cement composition comprises 0.05 to 1 wt %, preferably 0.1 to 0.3 wt % of the polycarboxylate ether formulation according to the present invention.

One aspect of the present invention is directed to a process for producing the cement composition as defined above, which comprises mixing the cement, water and the polycarboxylate ether formulation according to the present invention. According to the present invention, additives for cement can be further added to prepare the cement composition.

The cement composition can be mixed with small aggregate to form mortars. The mortars can be mixed with large aggregate to form concrete.

The defoamer emulsion of the present invention possesses excellent stability. The polycarboxylate ether formulation comprising the defoamer emulsion of the present invention also shows excellent stability, for example, the polycarboxylate ether formulation does not show phase separation at a temperature from 5° C. to 50° C. over a period of more than 2 months (even more than 6 months in some cases). The cement composition comprises the polycarboxylate ether formulation according to the present invention has a low air content.

Further embodiments of the present invention are described in the claims, the description and the examples. It goes without saying that the features mentioned above and features still to be explained below of the subject matter of the invention can be used not only in the combination indicated in each case but also in other combinations without going outside the scope of the invention.

The advantages of the invention are illustrated by the following examples.

### EXAMPLES

### A) Substances Used

SLES1 (Sodium lauryl ether sulfate, 50 EO, 32 wt % in water);

SLES2 (Sodium lauryl ether sulfate, 30 EO, 32 wt % in water);

SLES3 (Sodium lauryl ether sulfate, 12 EO, 30 wt % in water);

Calfax DB45 (diphenyl oxide disulfonate, 45 wt % in water, DOW);

SLS (sodium lauryl sulfate, 30 wt % in water);

AE030 (C13-Oxo alcohol ethoxylate, 30 EO, 70 wt % in water)

AE040 (C13-Oxo alcohol ethoxylate, 40 EO, 70 wt % in water);

Defoamer HS-568 (Propoxylated C₇-C₂₀ alcohol mixture, about 20 PO, 100%, San Nopco);

POPDMS (Modified silicone, a,w-modified propoxylated polydimethyl siloxane, molar mass of the polydimethyl siloxane=1000 g mol⁻¹, about 35PO, 100%);

PES (an aqueous polycarboxylate ether solution, 50 wt %, wherein the polycarboxylate ether is a copolymer of polyacrylic acid and allyl polyethylene glycol (weight ratio=3:1), 45 EO, number average molar mass=˜20,000 g mol⁻¹)

### B) Test Method

### Light Transmittance

0.05 g of defoamer emulsion prepared in the following examples or comparative examples is dispersed in 49.95 g of deionized water. The sample is transferred to the cuvette. The transmittance of the sample is measured with light at 600 nm by using DR/2010 from HACH. The results are shown in table 1.

To test the stability of the defoamer emulsions, the defoamer emulsions prepared in the following examples and comparative examples are stored over a period of 6 months at room temperature (RT) after preparation. Then, the light transmittances of the resulted defoamer emulsions are tested according to the above procedure. The results are shown in table 1.

### Formulation Stability Test

The polycarboxylate ether formulations prepared below are put in the oven (at 50° C.) and the fridge (at 5° C.) to observe phase separation visibly. The results are shown in table 2.

### Air Content Test

Air content of concrete prepared below is measured according to ASTM C 185(1995) and the results are shown in table 4.

### Average Droplet Diameter Test

The test sample is prepared by adding 0.2 g of the defoamer emulsion obtained in the following examples or comparative examples to 99.8 g deionized water. The average droplet diameter is measured by using the Malvern Nanosizer ZS 90 and is shown in table 1.

### Examples 1 to 10 and Comparative Examples 1 to 4

### Preparation of the Defoamer Emulsion

### Example 1

28.125 g of SLES2 is dissolved in 44.875 g deionized water. Then, 27 g of HS-568 is added and stirred with a propeller at 200 rpm for 10 minutes, which then results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 2

30 g of SLES3 is dissolved in 43 g deionized water. Then, 27 g of HS-568 is added and stirred with a propeller at 200 rpm for 10 minutes, which then results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 3

30 g of SLES1 is dissolved in 43 g deionized water. Then, 27 g of HS-568 is added and stirred with a propeller at 200 rpm for 10 minutes, which then results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 4

33.75 g of SLES2 is dissolved in 39.25 g deionized water. Then, 27 g of HS-568 is added and stirred with a propeller at 200 rpm for 10 minutes, which then results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 5

42.18 g of SLES2 is dissolved in 30.81 g deionized water. Then, 27 g of HS-568 is added and stirred with a propeller at 200 rpm for 10 minutes, which then results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 6

The procedure of Example 1 was repeated with the difference that the rough emulsion is subjected to an IKA Ultra-Turrax high-speed homogenizer with a S50B-G45G dispersing head and a T65 control unit at 10000 rpm (corresponding to shear rate of ˜30,000 s⁻¹) for 30 minutes.

### Example 7

The procedure of Example 1 was repeated with the difference that the rough emulsion is subjected to an IKA Ultra-Turrax high-speed homogenizer with a S50B-G45G dispersing head and a T65 control unit at 40000 rpm (corresponding to shear rate of ˜120,000 s⁻¹) for 30 minutes.

### Example 8

28.125 g of SLES2 is dissolved in 44.875 g water. Then, 27 g of POPDMS is added and stirred with a propeller at 200 rpm for 10 minutes, which then results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 9

28.125 g of SLES2 and 27 g of HS-568 are added in 44.875 g deionized water simultaneously and stirred with a propeller at 200 rpm for 10 minutes, which results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 10

28.125 g of SLES2 is dissolved in 44.875 g deionized water. Then, 27 g of HS-568 is added and stirred with a propeller at 200 rpm for 10 minutes, which results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 60 minutes, which then results in a fine emulsion.

### Example 11

28.125g of SLES2 is dissolved in 44.875 g deionized water. Then, 27 g of HS-568 is added. The mixture is then directly subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Example 12

28.125g of SLES2 and 4g of diethanol amine is dissolved in 40.875 g deionized water. Then, 27 g of HS-568 is added and stirred with a propeller at 200 rpm for 10 minutes, which then results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes, which then results in a fine emulsion.

### Comparative Example 1

28.125 g of SLES2 is dissolved in 44.875 g water. Then, 27 g of HS-568 is added and stirred with a propeller at 200 rpm for 10 minutes. No high-shear mixing is applied.

### Comparative Example 2

10 g of Calfax DB45 and 6.43 g of AE040 are dissolved in 56.57 g water. Then, 27 g of HS568 is added and stirred with a propeller at 200 rpm for 10 minutes. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes.

### Comparative Example 3

10.0 g of SLS and 8.57 g of AE030 are dissolved in 54.43 g water. Then, 27g of HS568 is added and stirred with a propeller at 200 rpm for 10 minutes. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes

### Comparative Example 4

27 g of Disponil HS568 is added in 64 g water and stirred with a propeller at 200 rpm for 10 minutes, which results in a rough emulsion. The rough emulsion is then subjected to an IKA Ultra-Turrax high-speed homogenizer with a S50B-G45G dispersing head and a T65 control unit at 20000 rpm (corresponding to shear rate of ˜60,000 s⁻¹) for 30 minutes.

The properties of the defoamer emulsions obtained in examples 1 to 10 and comparative 1 to 4 are shown in the following table 1.

TABLE 1

| | | Transmittance | Defoamer | average |
|---|---|---|---|---|
| | | after 6 months | emulsion | droplet |
| Example No. | Transmittance | storage at RT | stability | diameter |
| Example 1 | 82% | 78% | + + | 120 nm |
| Example 2 | 83% | 79% | + + | 125 nm |
| Example 3 | 81% | 78% | + + | 116 nm |
| Example 4 | 82% | 79% | + + | 119 nm |
| Example 5 | 82% | 77% | + | 120 nm |
| Example 6 | 75% | 67% | + | 250 nm |
| Example 7 | 95% | 90% | + | 95 nm |
| Example 8 | 85% | 82% | + + | 118 nm |
| Example 9 | 82% | 78% | + + | 120 nm |
| Example 10 | 90% | 88% | + + | 101 nm |
| Example 11 | 82% | 78% | + + | 120 nm |
| Example 12 | 82% | 78% | + + | 118 nm |
| Comparative | 23% | Not | − | 1000 nm |
| example 1 | | measurable | | |
| Comparative | 52% | Not | − | 720 nm |
| example 2 | | measurable | | |
| Comparative | 51% | Not | − | 732 nm |
| example 3 | | measurable | | |
| Comparative | 20% | Not | − | 1134 nm |
| example 4 | | measurable | | |

+ +: transmittance % decreases less than 5% after the defoamer emulsion is stored over a period of 6 months at room temperature.
+: transmittance % decreases by 5-15% after the defoamer emulsion is stored over a period of 6 months at room temperature.
−: complete phase separation after ~5 days storage at room temperature

### Preparation of the Polycarboxylate Ether Formulations

The PES (aqueous polycarboxylate ether solution, 50 wt %) is diluted to 25 wt % with deionized water. Each defoamer emulsion (0.6 g) prepared in above examples 1 to 10 and comparative examples 1 to 4 is then added to 99.4 g of the diluted aqueous polycarboxylate ether solution and mixed well using a hot plate at room temperature with stirring rate of ˜100 rpm to obtain the polycarboxylate ether formulation.

The properties of the polycarboxylate ether formulations are shown in the following table 2.

TABLE 2

| The defoamer | | | |
|---|---|---|---|
| emulsion in | Formulation | Formulation | Formulation |
| the Formulation | stability | stability | stability |
| from Example No. | at 50° C. | at 25° C. | at 5° C. |
| Example 1 | >6 months | >6 months | >6 months |
| Example 2 | >6 months | >6 months | >6 months |
| Example 3 | >6 months | >6 months | ~4 months |
| Example 4 | >6 months | >6 months | >6 months |
| Example 5 | >6 months | >6 months | >6 months |
| Example 6 | ~3 months | ~3 months | ~3 months |
| Example 7 | >6 months | >6 months | >6 months |
| Example 8 | >6 months | >6 months | ~2 months |
| Example 9 | >6 months | >6 months | >6 months |
| Example 10 | >6 months | >6 months | >6 months |
| Example 11 | >6 months | >6 months | ~6 months |
| Example 12 | >6 months | >6 months | >10 months |
| Comparative | Separation | Separation | Separation |
| example 1 | within 2 days | within 2 days | within 2 days |
| Comparative | Separation | Separation | Separation |
| example 2 | within 5 days | within 8 days | within 10 days |
| Comparative | Separation | Separation | Separation |
| example 3 | within 5 days | within 7 days | within 10 days |
| Comparative | Separation | Separation | Separation |
| example 4 | within 2 days | within 2 days | within 2 days |

### Preparation of the Concrete

Each polycarboxylate ether formulation prepared above (0.042 kg) is mixed with the ingredients shown in table 3 to prepare the concrete.

TABLE 3

| Component | Amount/kg |
|---|---|
| Cement (Hailuo cement 425) | 4.20 |
| Sand | 8.40 |
| Stone (diameter from 5 mm to 15 mm) | 9.20 |
| water | 1.70 |

Air contents in concretes prepared above are shown in the following table 4.

TABLE 4

| The defoamer emulsion in the | |
|---|---|
| Formulation from Example No. | Air content in concrete |
| Example 1 | 1.0% |
| Example 2 | 0.9% |
| Example 3 | 1.0% |
| Example 4 | 1.6% |
| Example 5 | 2.2% |
| Example 6 | 1.0% |
| Example 7 | 1.0% |
| Example 8 | 2.5% |
| Example 9 | 1.0% |
| Example 10 | 1.0% |
| Example 11 | 1.0% |
| Example 12 | 1.0% |
| Comparative example 1 | 1.0% |
| Comparative example 2 | 1.0% |
| Comparative example 3 | 1.1% |
| Comparative example 4 | 1.0% |

1. A defoamer emulsion, comprising
at least one alkyl ether sulfate or sulfonate,
at least one defoamer, and
water,
wherein the alkyl in the alkyl ether sulfate or sulfonate is C₆-C₂₂ alkyl and an average droplet diameter of the emulsion is less than 300 nm.

2. The defoamer emulsion according to claim 1, wherein the alkyl in the alkyl ether sulfate or sulfonate is C₈-C₁₈ alkyl.

3. The defoamer emulsion according to claim 1, wherein the alkyl ether sulfate or sulfonate is a sulfate or sulfonate of a polyethoxylated alkanol.

4. The defoamer emulsion according to claim 3, wherein the sulfate or sulfonate of the polyethoxylated alkanol has 4 to 80 oxyethylene units.

5. The defoamer emulsion according to claim 1, wherein the defoamer is a water-insoluble defoamer.

6. The defoamer emulsion according to claim 1, wherein the defoamer is selected from the group consisting of a silicon oil, a silicon containing emulsion, a fatty acid, a fatty acid ester, an organic modified polysiloxane, a borate ester, a polyalkoxylate, a polyoxyalkylene copolymer, an acetylenic diol having defoaming properties and a phosphoric ester having a formula P(O)(OR₈)₃₋ₓ(OR₉)ₓ wherein P represents phosphorus, O represents oxygen, R₈ and R₉, are independently C₂-C₂₀ alkyl or C₆-C₁₄ aryl group, and x is 0, 1 or 2, and a mixture thereof.

7. The defoamer emulsion according to claim 1, further comprising
at least one additive selected from the group consisting of polyvinylpyrrolidone, diethanol amine, triethanol amine, ethylene glycol, urea, and a carbonate salt, and a mixture thereof.

8. The defoamer emulsion according to claim 7, wherein the at least one additive is used in an amount of from 5 to 15 wt % when the additive is polyvinylpyrrolidone, or in an amount of from 1 to 8 wt % when the additive is selected from the group consisting of diethanol amine, triethanol amine, ethylene glycol, urea, a carbonate salt, and a mixture thereof, based on a total weight of the emulsion.

9. The defoamer emulsion according to claim 7, wherein the at least one additive comprises polyvinyl-pyrrolidone, which has a number average molecular weight ranging from 5,000 to 20,000.

10. The defoamer emulsion according to claim 1, wherein the average droplet diameter of the emulsion is from 80 to 300 nm.

11. The defoamer emulsion according to claim 1, wherein a concentration of the alkyl ether sulfate or sulfonate in the defoamer emulsion is from 5 to 20 wt %.

12. The defoamer emulsion according to claim 1, wherein a weight ratio of the alkyl ether sulfate or sulfonate to the defoamer is from 0.15:1 to 0.8:1.

13. A process for producing the defoamer emulsion according to claim 1, the process comprising
a) preparing a mixture comprising the alkyl ether sulfate or sulfonate, the defoamer and water;
b) optionally subjecting the mixture to a low shear; and
c) shearing the mixture at a shear rate of at least 25,000 s⁻¹, for at least 10 minutes.

14. The process according to claim 13, wherein a) is carried out by dissolving the alkyl ether sulfate or sulfonate in the water to obtain a solution and adding the defoamer to the solution or a) is carried out by adding the alkyl ether sulfate or sulfonate and the defoamer to the water simultaneously.

15. A defoamer emulsion, obtained by the process according to claim 13.

16. A polycarboxylate ether formulation, comprising
at least one polycarboxylate ether and
the defoamer emulsion according to claim 1.

17. The polycarboxylate ether formulation according to claim 16, wherein the polycarboxylate ether comprising a polycarboxylate moiety and an ether moiety.

18. The polycarboxylate ether formulation according to claim 17, wherein the polycarboxylate moiety is a carbon containing backbone bearing carboxylic acid group and/or an ester and/or a salt thereof, and optional sulfonic acid group and/or a salt thereof.

19. The polycarboxylate ether formulation according to claim 17, wherein a weight ratio between the polycarboxylate moiety and the ether moiety is from 3:7 to 99:1.

20. The polycarboxylate ether formulation according to claim 16, wherein a content of the polycarboxylate ether in the polycarboxylate ether formulation is from 5 to 40 wt % and a content of the defoamer emulsion is from 0.1 to 5 wt %, based on a total weight of the formulation.

21. A process for producing the polycarboxylate ether formulation according to claim 16, the process comprising
mixing the defoamer emulsion with the polycarboxylate ether.

22. The process according to claim 21, further comprising:
adding at least one additive selected from the group consisting of polyvinylpyrrolidone, diethanol amine, triethanol amine, ethylene glycol, urea, and a carbonate salt.

23. A cement composition, comprising
at least one cement and
the polycarboxylate ether formulation according to claim 16.

24. The cement composition according to claim 23, wherein the cement is selected from the group consisting of portland cement, masonry cement, alumina cement, refractory cement, magnesia cement, calcium sulfoaluminate cement, oil well cement, and a mixture thereof.

25. The cement composition according to claim 23, wherein the cement composition comprises 0.05 to 1 wt %, of the polycarboxylate ether formulation.

26. A process for producing the cement composition according to claim 23, the process comprising
mixing the cement, water, and the polycarboxylate ether formulation.
